(19) United States
(12) Patent Application Publication
(10) Pub. No.: US 2020/0343679 A1
(43) Pub. Date: Oct. 29, 2020

(54) CARBON BRUSH AND PRODUCTION METHOD

(71) Applicant: SCHUNK CARBON TECHNOLOGY GMBH, Bad Goisem (AT)

(72) Inventor: Sarah Reynvaan, Bad Goisern (AT)

(21) Appl. No.: 16/955,212

(22) PCT Filed: Dec. 20, 2018
(86) PCT No.: PCT/EP2018/086114

§ 371 Date: Jun. 18, 2020

(30) Foreign Application Priority Data
Dec. 27, 2017 (DE) 10 2017 131 340.0

(51) Int. Cl. H01R 43/12; H01R 39/20

(52) U.S. Cl. CPC H01R 43/12; H01R 39/20

(57) ABSTRACT

The invention relates to a carbon brush and a method for producing a carbon brush for electrically contacting a contact structure, in particular a commutator or a collector ring of an electric machine, moved with respect to the carbon brush, a brush body of the carbon brush being realized by pressing and hardening a material blend, the material blend being obtained by blending a graphite powder with a hardenable resin and an additive, wherein graphene is used as the additive.

The invention relates to a carbon brush and a method for producing a carbon brush for electrically contacting a contact structure, in particular a commutator or a collector ring of an electric machine, moved with respect to the carbon brush, a brush body of the carbon brush being obtained by pressing and hardening a material blend, the material blend being obtained by blending a graphite powder with a hardenable resin and an additive.

Carbon brushes are commonly made of a brush body or a brush body having a pigtail attached thereto, a damping element or the like. The brush body forms a contact surface which serves for electrically contacting a moved contact structure, such as a commutator or a collector ring. To produce the brush body, it has been known to blend carbon in the form of graphite powder with a binding agent and to process it to form the brush body in a compression molding method. Resins are commonly used as binding agents, auxiliary materials, such as solid lubricants and cleaning agents and even metal powder, being able to be added to a material blend made of the graphite powder and a resin as additives for setting a desired physical property of the carbon brush.

Thus, EP 1 713 148 A1 discloses a method for producing carbon brushes in which a metal powder is added to a powdered blend made of carbon powder and a thermoplastic binding agent and the powder blend is processed to form a brush body in compression molding process. With the known carbon composite material, metal powder is added to the carbon to influence a material resistance of the carbon brush.

If resin is used as a binding agent, the resin can be carbonized in the scope of heat-treating a pressed molded body of the brush body so that the resin is essentially changed completely to carbon. On the other hand, it can also be advantageous to merely harden the resin without carbonizing or pyrolyzing it. The resin can thus prolong the service life of the carbon brush due to its good tribological properties. An intermediary layer made of copper oxide and brush grit and containing a portion of resin regularly forms between the carbon brush, i.e., a contact surface of the brush body, and the contact structure, i.e., a commutator or a collector ring. This portion of resin yields an increased electric transition resistance and thus improves commutation. Thus, induced short-circuit currents must pass the intermediary layer twice through two neighboring slats of a commutator. However, the resin matrix of the brush body causes a specific resistance of the brush body to be increased with respect to a carbonaceous matrix due to the electric properties of the resin. Thus, as a matrix material, the resin encloses particles of the graphite powder which are only partially connected to each other in an electrically conductive manner. By tightly anchoring the particles of the graphite powder in the resin matrix, the carbon brushes have a long service life but are less stable when sparks arise.

The object of the invention at hand is therefore to propose a method for producing a carbon brush as well as the carbon brush itself which has a resin matrix and comprises a low specific resistance.

This object is attained by a method having the features of claim 1 and a carbon brush having the features of claim 14.

With the method according to the invention for producing a carbon brush for electrically contacting a contact structure, in particular a commutator or a collector ring of an electric machine, moved with respect to the carbon brush, a brush body of the carbon brush is obtained by pressing and hardening a material blend which is obtained by blending a graphite powder with a hardenable resin and an additive, graphene being used as the additive.

The material blend can be obtained with the aid of an extruder, for example, the material blend being hardened to form the brush body by hardening the resin which acts as the matrix material. Natural graphite, artificial graphite or electrographite can be used for the graphite powder. The graphene is a modification of the carbon having a two-dimensional structure in which each carbon atom is surrounded by another three atoms at a 120° angle. Layers and other parameters are universally chosen depending on the field of application. In particular the two-dimensional structure of the graphene enables bridging spaces between particles of the graphite powder, which are filled with resin, at least partially with graphene particles without enlarging these spaces, as would be the case with comparatively larger three-dimensional particles of different additives. The graphene particles advantageously intersperse the 0.1 to 1 μm thick resin layer around the graphite particles, without enlarging a distance between the graphite particles. This enables significantly improving an electric conductivity of the brush body and to reduce a specific resistance. Moreover, a contribution to friction which is provided in the resin phase is reduced and thus, among other things, a noise from the brush is reduced. Furthermore, the mechanical properties of the thus obtained brush body is also significantly improved. The addition of graphene can effectively prevent tears from forming in the brush body when being pressed or mechanically processed, for example by being drilled or ground. The stability and a heat conductivity of the brush body can thus be further increased. Aside from the thus improved conductivity of the brush body and the carbon brush, possible malfunctions of the carbon brush, for example breakage of the brush body, can be minimized during operation time. A field of application of the carbon brush is extended since arising sparks have less negative impact on the service life and on wear.

The carbon brush and the brush body can be obtained as early as the hardening of the resin, the hardening being able to take place at a temperature of ≤500° C. Thus, a pyrolysis of the resin or its change to carbon is prevented so that the initially described positive properties of the resin are maintained. Accordingly, carbonizing or pyrolyzing the resin is not intended in the scope of the method.

The brush body can have a portion of graphene at 0.01 to <5% by weight, preferably 0.01 to <3% by weight, particularly preferably 0.01 to <2% by weight. Surprisingly, this portion of graphene can significantly increase the performance of the carbon brush. At the same time, only little graphene needs to be added to the material blend, meaning that the improved performance of the carbon brush can be attained inexpensively.

Advantageously, the material blend can be made predominantly of graphite powder. Accordingly, the material blend can have a graphite portion of >50% by weight, preferably >90% by weight. The material blend can also comprise other materials, such as solid lubricants, abrasives and/or metal powder. The properties of the carbon brush and the brush body can thus be adapted to the respective use as desired.

The resin can be liquid and the graphene can be added to the liquid resin in particle shape before being mixed with the graphite powder. Generally, the resin can also be in powder shape, however, it is particularly advantageous if the resin is liquid since the graphene can be blended well with the liquid resin. The graphene can be used in particle shape as a kind of powder, the particles being plate-shaped having a two-dimensional structure. Depending on the production method of the graphene, the plates of the two-dimensional structure can be stacked or unstacked. At any rate, the particles of the graphene do not form a sphere.

The material blend can be obtained particularly easily if the liquid resin is diluted with a solvent, preferably acetone, the solvent being able to be removed after or during compression by means of heat treatment and the resin being able to be hardened. By being diluted with a solvent, a particularly homogeneous material blend can be obtained which can be easily processed in an extruder, for example. The graphene can then be blended particularly well with the resin. The resin can be hardened by the solvent vaporizing by means of heat treatment and thus being removed from the material blend and the thus realized brush body. When the solvent is heat-treated or vaporized, a temperature can be chosen such that the hardening process of the resin is commenced.

Alternatively thereto, the resin can be solid and be liquified using a solvent, the graphene being able to be added in particle shape to the liquid resin before being blended with the graphite powder, the resin being able to be hardened and be processed to a powder, the powder being able to be mixed with graphite powder. The powder can be blended with the graphite powder in an extruded manner.

Advantageously, the graphene and the resin can be homogeneously dispersed. This dispersion can then simply be blended with the graphite powder, whereby the graphene is easily distributed homogeneously throughout the material blend and thus in the brush body.

It has been discovered that a particularly high electrical conductivity of the brush body can be attained when graphene is used having a mean particle size of ≤2 μm.

The resin can be a thermoset or thermoplastic resin, epoxy resin, phenolic resin, novolak or siloxane being able to be used as the resin. The siloxane can be diorganopolysiloxane.

Graphene oxide (GO), reduced graphene oxide (rGO), graphene nanoplatelets (GNO) and/or carbon nanotubes (CNT) can be used as graphene which can each be single-layered or multilayered. The used graphene can be functionalized in particular as a function of its production method. By using a specific graphene, it becomes possible to advantageously adjust the properties of the carbon brush.

A further advantageous derivation of the properties of the carbon brush becomes possible if single-walled or multiwalled carbon nanotubes (CNT), carbon black and/or other graphene modifications are added to the additive. It is essential in particular when it comes to the carbon black that a particle size is comparatively small. Depending on the size distribution of the particles of the graphite powder, carbon black particles can advantageously fill larger spaces between the particles of the graphite powder.

The brush body can be multilayered, preferably double-layered or treble-layered, at least one layer having the additive and being able to be realized having a contact surface for electrically contacting the contact structure. A layer of the brush body facing away from the contact structure can have a deviating portion of graphene, for example, or even be free of graphene. The layers can differ insofar that they have differing portions of graphite powder and/or metal powder. Thus, a brush body can be obtained which enables a particularly good electrical contact at its contact surface and simultaneously a simple fastening to a strand at its end opposite the contact surface.

The carbon brush according to the invention for electrically contacting a contact structure, in particular a commutator or a collector ring of an electrical machine, moved with respect to the carbon brush is made of a brush body which consists of a hardened material blend made of a graphite powder having a hardened resin and an additive in particle shape, the additive being graphene. With regard to the advantageous effects of the carbon brush according to the invention, the description of advantages of the method according to the invention is referred to. Further advantageous embodiments of a carbon brush are derived from the dependent claims referring back to method claim 1.

1. A method for producing a carbon brush for electrically contacting a contact structure of an electric machine, moved with respect to the carbon brush, the method comprising:
forming a brush body of the carbon brush being obtained by pressing and hardening a material blend, the material blend being obtained by blending a graphite powder with a hardenable resin and an additive, characterized in that graphene is used as the additive.

2. The method according to claim 1, characterized in that the carbon brush is obtained by hardening the resin, the hardening taking place at a temperature of ≤500° C.

3. The method according to claim 1, characterized in that the brush body comprises graphene at a portion of 0.01 to <5% by weight.

4. The method according to claim 1, characterized in that the material blend is made predominantly of graphite powder.

5. The method according to claim 1, characterized in that the resin is liquid and the graphene is added in particle shape to the liquid resin before being blended with the graphite powder.

6. The method according to claim 5, characterized in that the liquid resin is diluted with a solvent, the solvent being removed before or during pressing by means of heat treatment and the resin being hardened.

7. The method according to claim 1, characterized in that the resin is hard and is liquefied, the graphene in particle shape being added to the liquid resin before being blended with the graphite powder, the resin becoming hardened and being ground to a powder, the powder being blended with the graphite powder.

8. The method according to claim 5, characterized in that graphene and resin are dispersed homogenously.

9. The method according to claim 1, characterized in that graphene of a mean particle size of ≤2 μm is used.

10. The method according to claim 1, characterized in that a thermoset or thermoplastic resin, novolak or siloxane, is used as the resin.

11. The method according to claim 1, characterized in that graphene oxide (GO), reduced graphene oxide (rGO), graphene nanoplatelets (GNO) and/or carbon nanotubes (CNT) are used as the graphene.

12. The method according to claim 1, characterized in that single-walled or multiwalled carbon nanotubes and/or carbon black is/are added to the additive.

13. The method according to claim 1, characterized in that the brush body is multilayered, at least one layer comprising the additive and being realized having a contact surface for electrically contacting the contact structure.

14. A carbon brush for electrically contacting a contact structure of an electric machine, moved with respect to the carbon brush, the carbon brush being made of a brush body comprising a hardened material blend made of graphite powder having a hardened resin and a particle-shaped additive, characterized in that the additive is graphene.
